(19) United States
(12) Patent Application Publication
(10) Pub. No.: US 2006/0251004 A1
(43) Pub. Date: Nov. 9, 2006

(54) Power management in an ieee 802.11 ibss wlan using an adaptive atim window

(75) Inventors: Zhun Zhong, Croton-On-Hudson, NY (US); Sunghyun Choi, Seoul (KR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/547,105

(22) PCT Filed: Feb. 23, 2004
(86) PCT No.: PCT/IB04/00488

§ 371 Date: Aug. 26, 2005

Related U.S. Application Data
(60) Provisional application No. 60/451,033, filed on Feb. 27, 2003.
(60) Provisional application No. 60/477,207, filed on Jun. 10, 2003.

(51) Int. Cl. H04B 7/185

(52) U.S. Cl. 370/318; 340/539.11; 340/539.3

(57) ABSTRACT

An apparatus and method are provided for power management in an Independent Basic Service Set (IBSS) Wireless Local Area Network (WLAN) based on adjusting ATIM window size dynamically. In the present invention, each STA uses the gap between the last overheard Ad-hoc traffic indication message ATIM frame transmission and the end of the ATIM window to determine whether to increase or decrease the size of its ATIM window. Each STA of an IBSS competes to send its Beacon containing the size of its ATIM window and the window size of the winner is adopted by all STAs of the IBSS.

The present invention relates to power management in an Independent Basic Service Set (IBSS) Wireless Local Area Network ELAN). More particularly, the present invention relates to power management in an Institute of Electrical and Electronics Engineers (IEEE) 802.11 IBSS WLAN. Most particularly, the present invention relates to optimizing throughput and power saving in an IBSS WLAN by adapting the Ad-hoc Traffic Indication Message (ATIM) window size to traffic conditions.

The wireless local area network (WLAN) is becoming the dominant network technology. This growth in popularity is due to the explosive growth in demand for portable wireless devices and communications networks to service these devices.

The WLAN supports two types of networks: the Infrastructure BSS and Independent BSS (IBSS). The basic service set (BSS) is the basic building block of a WLAN. Each BSS consists of at least two stations (STAs).

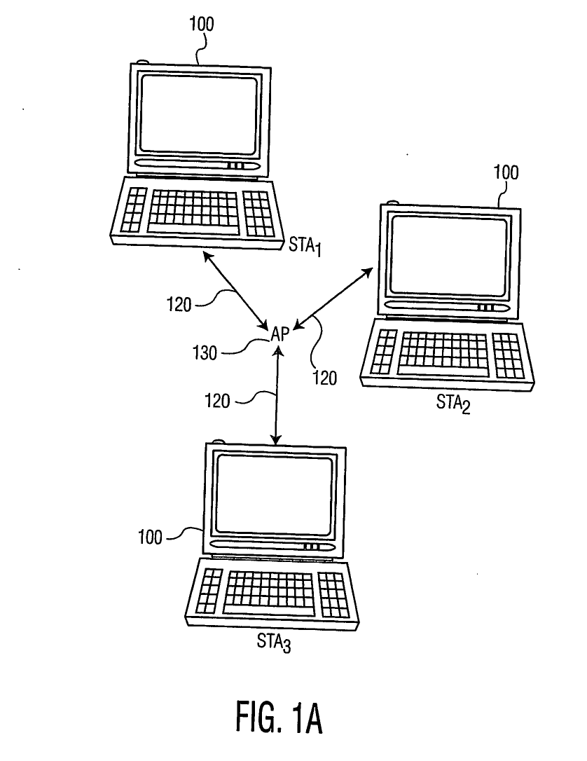

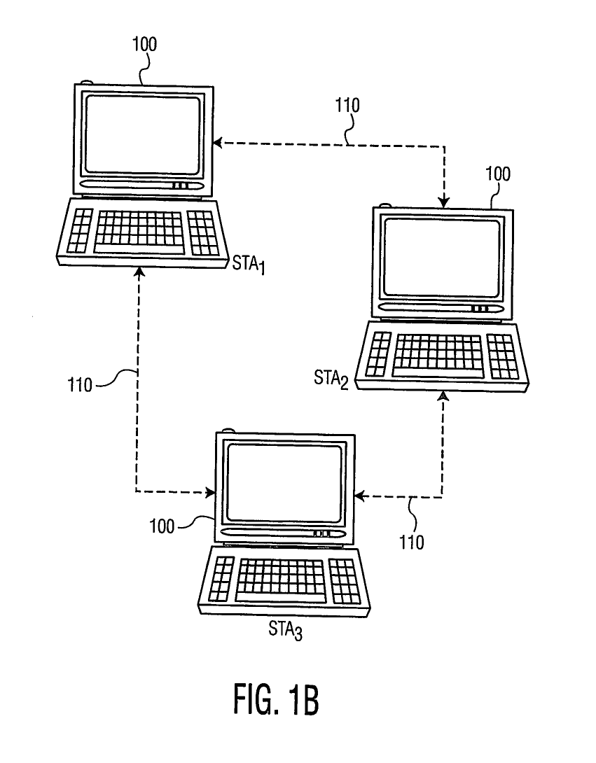

Referring to FIG. 1a, an Infrastructure BSS is illustrated in which STAs 100 communicate via a central access point (AP) 130 that receives traffic 120 from the source STA 100 and relays it 120 to the destination STA 100. Referring to FIG. 1b, an Independent BSS or IBSS is illustrated (also known as an Ad-hoc network) in which each STA 100 communicates 110 with other STAs 100 directly, without the assistance of an AP. That is, each STA 100 in an Ad-hoc network can communicate with another STA 100 if they are within radio range of one another since all traffic is peer-to-peer in an IBSS.

Many applications of a WLAN are for mobile devices which are battery-powered. Therefore power consumption of a WLAN card is a critical factor in overall IBSS WLAN power management. For example, an IEEE 802.11 standard WLAN utilizes carrier sense multiple access with collision avoidance (CSMA/CA) as the access method, requiring stations to continuously monitor the medium during idle time. As a result, the power consumed in the idle mode is not much less than the power consumed in the transmit or receive mode.

Power saving in a WLAN is achieved by allowing STAs, whenever appropriate, to enter a lower power consumption mode, i.e., sleep mode, during which the WLAN card does not monitor the medium. Note that entering sleeping mode is different from turning the WLAN card off, as it will take much longer and much more power to turn on the WLAN card from the off state than to awaken a WLAN card from sleep mode.

Sleep mode provides substantial power savings. However, although power is saved in sleep mode, the STAs in sleeping mode are totally isolated from the rest of the network. In sleep mode STAs can neither transmit nor receive any packets. This raises a problem: when a STA has packets to transmit and the destination STA is in sleep mode, namely, “How to wakeup the destination STA so that it can receive the packets?” That is, the challenge is to have the destination station wake up at the right time when the source station decides to transmit packets.

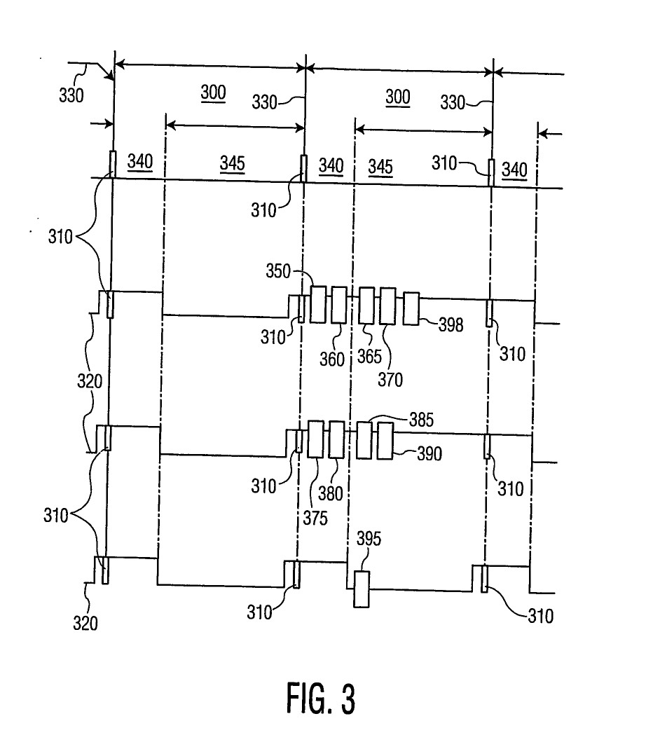

To solve this problem, an IBSS WLAN uses a Data_Alert message and a Data_Window to perform power management for the IBSS. FIG. 3 illustrates the operation of an IBSS WLAN. At a predetermined interval, known as Target Beacon Transmission Time (TBTT) 330, all STAs of the IBSS wake up and compete to send their Beacon 310 out because Beacon generation in an IBSS WLAN is distributed. Each STA in the IBSS has a Beacon 310 ready to transmit at the TBTT 330 and competes with all other STAs in the IBSS to access the medium using a random delay. The STA that wins the contention cancels all the other pending Beacon transmissions. Therefore, except for the case of Beacon failure, one Beacon 310 is transmitted per Beacon Interval 300.

A window of a predetermined length and that occurs right after the Beacon is reserved as a Data_Alert window 340, in which only Data_Alert frames 350 and the corresponding acknowledgements 360 can be transmitted. Data_Alert frames 350 are traffic announcements, used by source STAs to inform destination STAs that there are data frames buffered at a source STA waiting to be transmitted to a destination STA. The Data_Alert frames 350 (and their acknowledgements 380) resolve contention by following the same distributed coordination function (DCF) rules as normal data frames. Data_Alert frames 350 that cannot be transmitted before the Data_Alert window 340 ends are transmitted during the next Data_Alert window 340 which follows the next TBTT 330.

After the Data_Alert window 340 is over, if a STA doesn't successfully send or receive any Data_Alert frames 350 375, it can assume that there will be no traffic for it during the current Beacon Interval 340 and, thus, it can go back to sleep (low power mode) until the next TBTT 330. Otherwise, a STA can start transmission of data frames 365 and receipt of acknowledgements 370 or stay in the receiving mode throughout the Beacon Interval 340 to receive a data frame 385 and transmit an acknowledgement 390. Note that only the data that is announced during the Data_Alert window 340 can be transmitted after the Data_Alert window 340.

Current approaches to power management require the Data_Alert window size to be a fixed size throughout the lifespan of an IBSS where the Data_Alert window size is determined by the STA initiating the IBSS. The Data_Alert window size is included in the IBSS parameter set element with the Beacon 330 sent by the winning STA at TBTT 330. The Data_Alert window size is also available in the Probe Response frames in response to a Probe Request frame. The STA that creates a new IBSS sets the value of the size of the Data_Alert window 340 in the Beacon 330 and Probe Response frames and upon joining an existing IBSS, a STA updates its Data_Alert window size to the value specified in the Beacon 330 or Probe Response frame it receives.

The power management scheme of prior art IBSS WLANs can be summarized as follows. A STA periodically wakes up for a small period of time during which everyone else is also known to be awake. Within this period, STAs try to “book” their destination STAs for the packets they have buffered. At the end of this period, a STA by default goes back to sleep unless it has booked any destination STA or has been booked as a destination STA during the period.

This prior art power management scheme divides the Beacon Interval 300 into two mutually exclusive segments: the Data_Alert window 340, within which only the Data_Alert traffic announcements 350 and corresponding acknowledgements 380 can be transmitted, and the remainder of the Beacon Interval 345.

If the Data_Alert window 340 is too small, all the Data_Alert frames 350 cannot be transmitted during the Data_Alert window 340. As a result, the data frames of the un-announced traffic that could have been transmitted in the current Beacon Interval 300 has to wait until the next Beacon Interval 300. This causes unnecessary delay and wastes channel bandwidth.

Conversely, as the Data_Alert window 340 size increases, there is a corresponding decrease in the time left 345 in the current Beacon Interval during which transmission of corresponding data frames 365 and their acknowledgements 380 can take place. If the Data_Alert window 340 becomes too large, a good portion of the time towards the end of the Data_Alert window 340 is idle. This also results in a waste of bandwidth, as data frames cannot be transmitted during the Data_Alert window 340 but only during the remainder 345 of a Beacon Interval 300.

Therefore, no single Data_Alert window size is optimal in a dynamic network environment, such as an IBSS. The optimal Data_Alert window size depends on factors such as the number of STAs in the IBSS and the traffic load. A general rule of thumb is that, up to some certain traffic load, the larger the number of STAs and the heavier the network load, the larger the Data_Alert window 340 should be, and vice versa.

Accordingly, there is a need for the Data_Alert window size to be adaptive to the network conditions for optimal performance.

A Data_Alert window 340 corresponds to an IEEE 802.11 Ad-hoc traffic indication message (AT) window. There have been proposals to change the ATIM window size adaptively according to the observed network conditions. In the INFOCOM′2002 paper “An Energy Efficient MAC Protocol for Wireless LANs” by Eun-Sun Jung and Nitin Vaidya, the entire contents of which are hereby incorporated by reference as if fully set forth herein, the authors proposed to an approach in which each STA locally adapts its ATIM window size. As a result, each STA may have a different ATIM window size. A potential problem in this approach is the contention that will occur between data frames from STAs with small ATIM window and the ATIM frames from the STAs with large ATIM window, which is counter to the underlying philosophy that the ATIM window 340 is designed to separate traffic announcement from data transmission. Moreover, it is possible that some ATIM frames cannot be received by the destination STAs since the destination STAs are in sleep mode due to their small ATIM window sizes.

A solution to this problem in a power management scheme in which all the STAs of an IBSS employ the same Data_Alert window size is to adapt dynamically according to network load conditions.

In order to synchronize all the STAs of a BSS, the IEEE 802.11 standard defines a timing synchronization function using a periodic Beacon. The Beacon also serves other purposes by conveying information defined in its fields. For example, ATIM/Data_Alert window size is included in the IBSS parameter set element in the Beacon for IBSS.

At a predetermined interval, known as Target Beacon Transmission Time (TBTT) 330, all STAs in an IBSS wake up and compete to send their Beacon 310 out because Beacon generation in an IBSS WLAN is distributed. Each STA in the IBSS has a Beacon 310 ready to transmit at the TBTT 330 and competes with an other STAs in the IBSS to access the medium using a random delay. The STA that wins the contention effectively cancels all the other pending Beacon transmissions. Therefore, except for the case of Beacon failure, one Beacon is transmitted per Beacon Interval 300.

In the present invention, each STA updates it Data_Alert window size to a value it sees appropriate upon expiration of the current Data_Alert window 340. The new size for a STAs Data_Alert window 340 is based on the network conditions observed by the STA. This Data_Alert window size is incorporated by each STA in its Beacon. At each TBTT 330, the Data_Alert window size of the IBSS is set to the size determined by the STA that wins the contention to send its Beacon. All other STAs receive the winning Beacon and reset their Data_Alert window sizes to the size contained in the winning Beacon 310.

In the prior art IEEE 802.11 standard, Data_Alert window 340 is an Ad-hoc traffic indication message (ATIM) window and Data_Alert frames 350 are ATIM frames. Accordingly, the apparatus and method of the present invention allows STAs of an IBSS WLAN to take advantage of observations of network conditions made by a STA during a given Beacon Interval and use these observations to adjust the size of the ATIM window 340. Then, when the STAs compete for sending their Beacon at the next TBTT 330, each STA includes its adjusted ATIM window size and the winning STA's size is accepted by all other STAs as the ATIM window size for the Beacon Interval getting underway.

The foregoing and other features and advantages of the present invention will be apparent from the following, more detailed description of preferred embodiments as illustrated in the accompanying drawings.

FIG. 1a illustrates an infrastructure BSS WLAN.

FIG. 1b illustrates and independent BSS or IBSS WLAN.

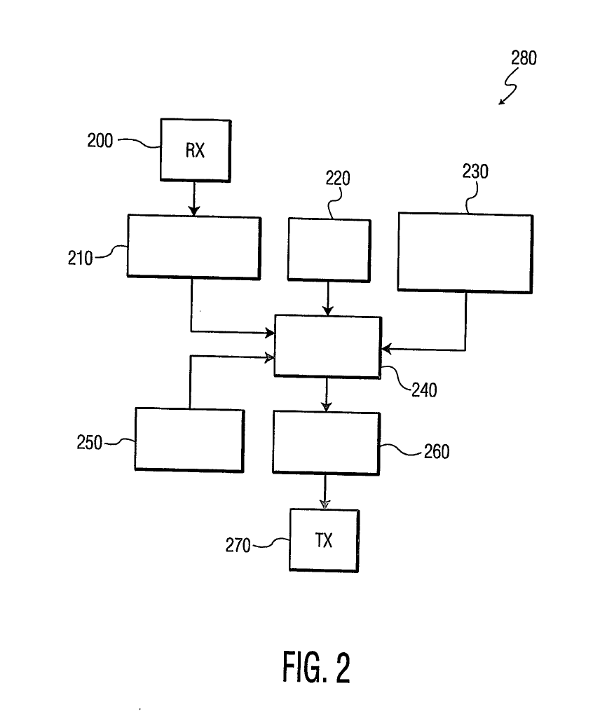

FIG. 2 illustrates a simplified block diagram of each STA within a particular IBSS according to an embodiment of the present invention.

FIG. 3 illustrates power management operation in IBSS according to an embodiment of the present invention.

In the following description, by way of example and not limitation, specific details are set forth such as the particular architecture, power management techniques, etc., in order to provide a thorough understanding of the present invention. However, to one skilled in the art it will apparent that the present invention may be practiced in other embodiments that depart from the specific details set forth.

In the prior art 802.11 standard, defined in International Standard ISO/IED 8802-11, “Information Technology—Telecommunications and information exchange area networks”, 1999 Edition, which is hereby incorporated by reference in its entirety, the ATIM window size is set by the STA that establishes the IBSS and is fixed in size for the life of the C3BSS. Every STA joining the 5IBSS sets its ATIM window size to this fixed size ATIM window.

In a preferred embodiment, upon Data_Alert window expiration the present invention provides a system and method by which each STA can set its Data_Alert window size to a value that the STA sees as appropriate. Each STA's decision is based on the network conditions observed by the individual STA.

FIG. 1b illustrates a representative network whereto embodiments of the present invention are to be applied. As illustrated in FIG. 1b, a plurality of STAs 100 communicates through a wireless link with each other via a plurality of wireless channels 110 such that all traffic is peer-to-peer. It should be noted that the IBSS network shown in FIG. 1b is small for purposes of illustration. In practice most networks include a much larger number of mobile STAs 100.

A key principle of the present invention is to provide a Data_Alert window size adjustment mechanism that optimizes power use by each wireless STA 100 such that within each Beacon Interval 300 the maximum number of data frames 365 are transmitted between the STAs 100. The present invention provides the following rules for each STA to use in selecting a new Data_Alert window size.

1. Each STA keeps track of the completion time of the last Data_Alert frame 350 it hears over the air during the current Data_Alert window 340. Upon Data_Alert window 340 expiration, each STA calculates the gap between the last Data_Alert frame 350 completion and the end of Data_Alert window 340. If the gap is larger than a predetermined MAX_GAP threshold, the STA decreases the size of the Data_Alert window 340 by a predetermined DECR_AMT. Note that there is a preset minimum value, DA_MIN, for the Data_Alert window size.

2. Each STA keeps track of the number of un-announced Data_Alert frames 350 it has buffered. Upon Data_Alert window 340 expiration, if the number of un-announced Data_Alert frames 350 is greater than a predetermined MAX_FR threshold, the STA increases the size of the Data_Alert window 340 by a predetermined INCR_AMT. Note that there is a preset maximum value, DA_MAX, for the Data_Alert window size. In a preferred embodiment, a STA does not increase the size of the Data_Alert window 340 beyond the maximum value of DA_MAX.

By using these two rules, each STA is able to select a size for its Data_Alert window 340 that is appropriate to the network conditions it has just observed. At the next TBTT, i.e., the next Beacon time, all the STAs compete to send their Beacon out. In the end, one will win out. Every other STA receiving the winning Beacon cancels its own pending Beacon and updates the size of its Data_Alert window 340 to the value specified in the winning Beacon.

It should be noted that the above-discussed Data_Alert window size adaptation rules may result in different Data_Alert window sizes being picked by different STAs. In the end, however, the distributed Beacon contention scheme only allows one Beacon to win, and the size of the winner's Data_Alert window 340 is adopted by all STAs in the Beacon Interval following the TBTT 330.

According to the prior art Beacon generation rule, each STA has an equal chance to win the contention, as the backoff delay is uniformly distributed in the contention window that is common to all the STAs. Thus, the expected value of the new size of the Data_Alert window 340 is the average of all the sizes for the Data_Alert window 340 selected by each STA.

In a preferred embodiment, one can change the probability that a STA wins the Beacon contention depending on the size of its desired Data_Alert window 340. For example, a STA that has selected a larger size for its Data_Alert window 340 can be given an increased chance to win the Beacon contention. This is desirable especially when the bandwidth is of less concern than the packet delay. If STAs choosing a larger size Data_Alert window 340 lose the contention and a small size Data_Alert window 340 is adopted, some of the buffered packets may have to wait until the next Beacon Interval simply because they can not be announced during the small size Data_Alert window. An increased chance to win the contention is achieved by having a smaller contention window size CW_SIZE. Therefore, the STAs selecting a larger size for their Data_Alert window 340 use a smaller contention window size, CW_SMALL, to send their Beacon. This suggests a negative correlation between size of Data_Alert 340 and size of contention window for Beacon contention purposes.

Referring to FIGS. 1b and 2, each STA 100 of an IBSS within the WLAN of FIG. 1b may include a system with an architecture that is illustrated in the block diagram of FIG. 2. Each STA 100 may include a receiver 200, a demodulator 210, a memory 220, a power management circuit 230, a control processor 240, a timer 250, a modulator, 260, and a transmitter 270. The exemplary system 280 of FIG. 2 is for descriptive purposes only. Although the description may refer to terms commonly used in describing particular mobile STAs, the description and concepts equally apply to other processing systems, including systems having architectures dissimilar to that shown in FIG. 2.

Since a wireless medium is a broadcast medium, every STA 100 can overhear the traffic over the medium within a certain range and records the time of the last Data_Alert frame it hears. When the Data_Alert window 340 ends, every STA 100 computes the time between the recorded time and the time at which the Data_Alert window 340 ended. In operation, the receiver 200 and the transmitter 270 are coupled to an antenna (not shown) to convert received signals and desired transmit data via the demodulator 210 and the modulator 260, respectively. The time TBTT of the start of the current Beacon Interval 300 and the time of the last Data_Alert overheard are stored in the memory 230. When the Data_Alert window 340 ends, the control processor 240 computes the GAP between the last Data_Alert overheard and the time Data_Alert window 340 ended.
GAP=Time (End of Data_Alert Window)−Time (Last Data_Alert Overheard)

If the computed GAP is greater than a predetermined MAX_GAP, then the size of the Data_Alert window 340 is decreased by a predetermined amount, but in any case cannot be decreased below a preset minimum size.

if

GAP > MAX_GAP

then

NEW_DA_SIZE = MAX[DA_MIN, OLD_DA_SIZE −

DA_DECR]

If the number of un-announced Data_Alert frames, NO_DA, is greater than a pre-determined MAX_NO_DA, then the size of the Data_Alert window 340 is increased by a predetermined amount DA_INCR, but in any case cannot be increased above a preset maximum size DA_MAX.

if

NO_DA > MAX_NO_DA

then

NEW_DA_SIZE = MIN[DA_MAX, OLD_DA_SIZE +

DA_INCR]

Based on the number of un-announced Data_Alert frames, the control processor 240 determines if the STA 100 should increase the size of its Data_Alert window 340. The control processor 240 computes and stores in memory 230 the new size of the Data_Alert window 340 for the STA 100 to send in its Beacon at the next TBTT to all STAs.

While the invention has been described with reference to the exemplary preferred embodiments thereof, those skilled in the art will be able to make various modifications to the described embodiments of the invention without departing from the true spirit and scope of the invention as embodied in the appended claims.

1. A method for power management by a wireless station (STA) (100) of a network having a plurality of wireless STAs (100), comprising the steps of:
(a) observing network conditions;
(b) changing a Data_Alert window (340) size in accordance with the observed network conditions; and
(c) competing with other STAs (100) of said plurality of STAs (100) for adoption of the changed Data_Alert window (340) size.

2. The method of claim 1, wherein:
said network is an IEEE 802.11 Independent Basic Service SET (IBSS) Wireless Local Area Network (WLAN); and
said Data_Alert window (340) is an Ad-hoc Traffic Indication Message (ATIM) window.

3. A method according to claim 1, wherein:
the step (a) of observing further comprises the step of
(a.1) recording the time at which a Data_Alert frame (350) is sent by any STA (100) of said plurality of STAs (100);
the step (b) of changing further comprises the steps of—
(b.1) when the Data_Alert window (340) has expired at an expiration time, computing a GAP as the difference between the expiration time and the recorded time,
(b.2) if the computed GAP is greater than a pre-determined MAX_GAP, setting the Data_Alert window (340) size for the STA (100), DA_SIZE, to the maximum of a pre-set minimum Data_Alert window (340) size, DA_MIN, and DA_SIZE—DA_DECR, wherein DA_DECR is a pre-set amount by which to decrement the size of the Data_Alert window (340), that is—
if
GAP > MAX_GAP
then
DA_SIZE = max[DA_MIN, DA_SIZE − DA_DECR].

4. The method of claim 3, wherein:
said network is an IEEE 802.11 Independent Basic Service SET (IBSS) Wireless Local Area Network (WLAN);
said Data_Alert window (340) is an Ad-hoc Traffic Indication Message (ATIM) window; and
said Data_Alert frame (350) is an ATIM frame.

5. The method of claim 1, wherein:
the step (a) of observing further comprises the step of
(a.2) tracking the number of un-announced Data_Alert frames (350), NO_DA, buffered by the STA (100) for transmission to a destination STA (100) of said plurality of STAs (100); and
the step (b) of changing further comprises the step of—
(b.3) when the Data_Alert window (340) has expired and the tracked NO_DA is greater than a predetermined MAX_NO_DA, setting a Data_Alert window (340) size for the STA, DA_SIZE, to the minimum of a pre-set maximum Data_Alert window (340) size, DA_MAX, and DA_SIZE+DA_INCR, where DA_INCR is a pre-set amount by which to increment the size of the Data_Alert window (340), that is—
if
NO_DA > MAX_NO_DA
then
DA_SIZE = max[DA_MAX, DA_SIZE + DA_INCR].

6. The method of claim 5, wherein:
said network is an IEEE 802.11 Independent Basic Service SET (IBSS) Wireless Local Area Network (WLAN);
said Data_Alert window (340) is an Ad-hoc Traffic Indication Message (ATIM) window; and
said Data_Alert frame (350) is an ATIM frame; and
said Beacon (310) contains the changed Data_Alert window (340) size.

7. The method of claim 1, wherein:
said competing step takes place at a predetermined and periodic Target Beacon Transmission Time (TBTT) (330); and
said competing step (c) further comprises the step of
(c.1) sending a Beacon (310) containing the Data_Alert window (340) size changed by the STA (100), wherein the Beacon (310) of one STA (100) of said plurality of STAs (100) is the winner of the competition.

8. The method of claim 7, wherein:
said network is an IEEE 802.11 Independent Basic Service SET (IBSS) Wireless Local Area Network (WLAN);
said Data_Alert window (340) is an Ad-hoc Traffic Indication Message (ATIM) window; and
said Data_Alert frame (350) is an ATIM frame.

9. The method of claim 3, wherein:
said competing step takes place at a predetermined and periodic Target Beacon Transmission Time (TBTT) (330); and
said competing step (c) further comprises the step of
(c.1) sending a Beacon (310) containing the Data_Alert window (340) size changed by the STA (100), wherein the Beacon (310) of one STA (100) of said plurality of STAs (100) is the winner of the competition.

10. The method of claim 9, wherein:
said network is an IEEE 802.11 Independent Basic Service SET (IBSS) Wireless Local Area Network (WLAN);
said Data_Alert window (340) is an Ad-hoc Traffic Indication Message (ATIM) window; and p1 said Data_Alert frame (350) is an ATIM frame.

11. The method of claim 3, wherein:
the step (a) of observing further comprises the step of
(a.2) tracking the number of un-announced Data_Alert frames, NO_DA, buffered by the STA (100) for transmission to a destination STA (100) of said plurality of STAs (100); and
the step (b) of changing further comprises the step of—
(b.3) when the Data_Alert window (340) has expired and the tracked NO_DA is greater than a pre-determined MAX_NO_DA, setting a Data_Alert window (340) size for the STA, DA_SIZE, to the minimum of a pre-set maximum Data_Alert window (340) size, DA_MAX, and DA_SIZE +DA_INCR, where DA_INCR is a pre-set amount by which to increment the size of the Data_Alert window (340), that is—
if
NO_DA > MAX_NO_DA
then
DA_SIZE = max[DA_MAX, DA_SIZE + DA_INCR].

12. The method of claim 11, wherein:
said network is an IEEE 802.11 Independent Basic Service SET (IBSS) Wireless Local Area Network (WLAN);
said Data_Alert window (340) is an Ad-hoc Traffic Indication Message (ATIM) window; and
said Data_Alert frame (350) is an ATIM frame.

13. The method of claim 11, wherein:
said competing step takes place at a predetermined and periodic Target Beacon Transmission Time (TBTT) (330); and
said competing step (c) further comprises the step of
(c.1) sending a Beacon (310) containing the Data_Alert window (340) size changed by the STA (100), wherein the Beacon (310) of one STA (100) of said plurality of STAs (100) is the winner of the competition.

14. The method of claim 13, wherein:
said network is an IEEE 802.11 Independent Basic Service SET (BSS) Wireless Local Area Network (WLAN);
said Data_Alert window (3430) is an Ad-hoc Traffic Indication Message (ATIM) window; and
said Data_Alert frame (350) is an ATIM frame.

15. An apparatus for power management by a wireless station (STA) of a network having a plurality of wireless STAs, comprising:
a control component (280) being configured to:
observe network conditions;
change a Data_Alert window (340) size in accordance with the observed network conditions; and
compete with other STAs (100) of said plurality of STAs (100) for adoption of the changed Data_Alert window (340) size.

16. The apparatus of claim 15, wherein:
said control component (280) comprises a memory (220); and
said control component (280) is further configured to:
periodically, at a Target Beacon Transmission Time (TBTT) (330), send a Beacon (310) containing the Data_Alert window (340) size of the STA (100) to compete with a Beacon (310) of every other STA (100) of said plurality of STAs (100), wherein one Beacon (310) wins the competition;
adopt the Data_Alert window (340) size of a winning Beacon (310);
record in the memory (220) the time at which a Data_Alert frame (350) is sent by any STA (100) of said plurality of STAs (100);
when the Data_Alert window (340) has expired at an expiration time—compute a GAP as the difference between the expiration time and the recorded time, and
when the computed GAP is greater than a predetermined MAX_GAP, set the Data_Alert window (340) size of the STA, DA_SIZE, to the maximum of a pre-set minimum Data_Alert window (340) size, DA_MIN, and DA_SIZE—DA_DECR, where DA_DECR is a pre-set amount by which to decrement the size of the Data_Alert window (340), i.e,
if
GAP > MAX_GAP
then
DA_SIZE = max[DA_MIN, DA_SIZE − DA_DECR];
track the number of un-announced Data_Alert frames, NO_DA, buffered by the STA (100) for transmission to a destination STA (100) of said plurality of STAs (100), and
when the tracked NO_DA is greater than a pre-determined MAX_NO_DA, set the Data_Alert window (340) size for the STA, DA_SIZE, to the minimum of a pre-set maximum Data_Alert window (340) size, DA_MAX, and DA_SIZE+DA_INCR, where DA_INCR is a pre-set amount by which to increment the size of the Data_Alert window (340), i.e.,
if
NO_DA > MAX_NO_DA
then
DA_SIZE = max[DA_MAX, DA_SIZE + DA_INCR].

17. The apparatus of claim 16, wherein:
the network is and IEEE 802.11 Independent Basic Service Set (IBSS) Wireless Local Area Network (WLAN);
the Data_Alert window (340) is an Ad-hoc Traffic Indication Message (ATIM) window; and
the Data_Alert frame (350) is an ATIM frame.
